(19) United States
(12) Patent Application Publication
(10) Pub. No.: US 2024/0170002 A1
(43) Pub. Date: May 23, 2024

(54) DEREVERBERATION BASED ON MEDIA TYPE

(71) Applicant: DOLBY LABORATORIES LICENSING CORPORATION, San Francisco, CA (US)

(72) Inventors: Kai LI, Beijing (CN); Shaofan YANG, Beijing (CN); Yuanxing MA, Beijing (CN)

(73) Assignee: DOLBY LABORATORIES LICENSING CORPORATION, San Francisco, CA (US)

(21) Appl. No.: 18/549,575

(22) PCT Filed: Mar. 10, 2022
(86) PCT No.: PCT/US2022/019816

§ 371 Date: Sep. 7, 2023

Related U.S. Application Data
(60) Provisional application No. 63/180,710, filed on Apr. 28, 2021.

(30) Foreign Application Priority Data
Mar. 11, 2021 (WO) PCT/CN2021/080314
May 18, 2021 (EP) 21174289.5

(51) Int. Cl. G10L 21/0232; G10L 21/0208; G10L 21/028; G10L 25/18; G10L 25/21; G10L 25/51

(52) U.S. Cl. CPC G10L 21/0232; G10L 21/028; G10L 25/18; G10L 25/21; G10L 25/51; G10L 2021/02082

(57) ABSTRACT

A method for reverberation suppression may involve receiving an input audio signal. The method may involve classifying a media type of the input audio signal as one of a group comprising at least: 1) speech; 2) music; or 3) speech over music. The method may involve determining whether to perform dereverberation on the input audio signal based at least on a determination that the media type of the input audio signal has been classified as speech. The method may involve generating an output audio signal by performing dereverberation on the input audio signal in response to determining that dereverberation is to be performed on the input audio signal.

### CROSS-REFERENCE TO RELATED APPLICATIONS

This application claims priority of the following priority applications: International Patent Application No. PCT/CN2021/080314, filed Mar. 11, 2021, U.S. Provisional Patent Application No. 63/180,710, filed Apr. 28, 2021 and European Patent Application No. 21174289.5, filed May 18, 2021.

### TECHNICAL FIELD

This disclosure pertains to systems, methods, and media for dereverberation. This disclosure further pertains to systems, method and media for classifying an input audio signal.

### BACKGROUND

Audio devices, such as headphones, speakers, etc. are widely deployed. People frequently listen to audio content (e.g., podcasts, radio shows, television shows, music videos, etc.) that may include mixed types of media content, such as speech, music, speech over music, etc. Such audio content may include reverberation. It can be difficult to perform reverberation suppression on audio content, particularly, user-generated audio content that includes mixed types of media content.

### NOTATION AND NOMENCLATURE

Throughout this disclosure, including in the claims, the terms “speaker,” “loudspeaker” and “audio reproduction transducer” are used synonymously to denote any sound-emitting transducer (or set of transducers) driven by a single speaker feed. A typical set of headphones includes two speakers. A speaker may be implemented to include multiple transducers (e.g., a woofer and a tweeter), which may be driven by a single, common speaker feed or multiple speaker feeds. In some examples, the speaker feed(s) may undergo different processing in different circuitry branches coupled to the different transducers.

Throughout this disclosure, including in the claims, the expression performing an operation “on” a signal or data (e.g., filtering, scaling, transforming, or applying gain to, the signal or data) is used in a broad sense to denote performing the operation directly on the signal or data, or on a processed version of the signal or data (e.g., on a version of the signal that has undergone preliminary filtering or pre-processing prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X−M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

Throughout this disclosure including in the claims, the term “couples” or “coupled” is used to mean either a direct or indirect connection. Thus, if a first device couples to a second device, that connection may be through a direct connection, or through an indirect connection via other devices and connections.

Throughout this disclosure including in the claims, the term “classifier” is generally used to refer to an algorithm that predicts a class of an input. For example, as used herein, an audio signal may be classified as being associated with a particular media type, such as speech, music, speech over music, and the like. It should be understood that various types of classifiers may be used to implement the techniques described herein, such as decision trees, Ada-boost, XG-boost, Random Forests, Generalized Method of Moments (GMM), Hidden Markov Models (HMMs), Naïve Bayes, and/or various types of neural networks (e.g., a Convolutional Neural Network (CNN), Deep Neural Network (DNN), Recurrent Neural Network (RNN), Long Short-Term Memory (LSTM), Gated Recurrent Unit (GRU), and the like).

### SUMMARY

At least some aspects of the present disclosure may be implemented via methods. Some methods may involve receiving an input audio signal. Some such methods may involve classifying a media type of the input audio signal as one of a group comprising at least: 1) speech; 2) music; or 3) speech over music. Some such methods may involve determining whether to perform dereverberation on the input audio signal based at least on a determination that the media type of the input audio signal has been classified as speech. Some such methods may involve generating an output audio signal by performing dereverberation on the input audio signal in response to determining that dereverberation is to be performed on the input audio signal.

In some examples, a method may involve determining a degree of reverberation in an input audio signal, wherein determining whether to perform dereverberation on the input audio signal may be based on the degree of reverberation. In some examples, the degree of reverberation may be based on at least one of: 1) a reverberation time (RT60); or 2) a Direct-to-Reverberant Ratio (DRR); or an estimation of diffuseness. In some examples, determining a degree of reverberation may involve calculating a two-dimensional acoustic-modulation frequency spectrum of the input audio signal, where the degree of reverberation may be based on an amount of energy in a high modulation frequency portion of the two-dimensional acoustic-modulation frequency spectrum. In some examples, determining a degree of reverberation may involve calculating at least one of: 1) a ratio of energy in a high modulation frequency portion of the two-dimensional acoustic-modulation frequency spectrum to energy over all modulation frequencies in the two-dimensional acoustic-modulation frequency spectrum; or 2) a ratio of energy in the high modulation frequency portion of the two-dimensional acoustic-modulation frequency spectrum to energy in a low-modulation frequency portion of the two-dimensional acoustic-modulation frequency spectrum.

In some examples, a method may involve determining whether to perform dereverberation on an input audio signal based on a determination that a degree of reverberation exceeds a threshold.

In some examples, a method may involve classifying a media type of an input audio signal by separating an input audio signal into two or more spatial components. According to some implementations, the two or more spatial components may comprise a center channel and a side channel. In some examples, the method may further involve calculating a power of the side channel and classifying the side channel in response to determining that the power of the side channel exceeds a threshold. According to other implementations, the two or more spatial components comprise a diffuse component and a direct component. In some examples, classifying a media type of an input audio signal may involve classifying each of the two or more spatial components as one of: 1) speech; 2) music; or 3) speech over music, where the media type of the input audio signal may be classified by combining classifications of each of the two or more spatial components. In some examples, an input audio signal may be separated into the two or more spatial components in response to determining that the input audio signal comprises stereo audio.

In some examples, a method may involve classifying a media type of an input audio signal by separating the input audio signal into a vocal component and a non-vocal component. In some examples, an input audio signal may be separated into a vocal component and a non-vocal component in response to determining that the input audio signal comprises a single audio channel. In some examples, a method may further involve classifying the vocal component as one of: 1) speech; or 2) non-speech. The method may further involve classifying the non-vocal component as one of: 1) music; or 2) non-music. In some examples, the media type of the input audio signal may be classified by combining the classification of the vocal component and the classification of the non-vocal component.

In some examples, determining whether to perform dereverberation on the input audio signal may be based on a classification of a second input audio signal that preceded an input audio signal.

In some examples, a method may involve receiving a third input audio signal. The method may further involve determining that dereverberation is not to be performed on the third input audio signal. The method may further involve inhibiting a dereverberation algorithm from being performed on the third input audio signal in response to determining that dereverberation is not to be performed on the third input audio signal. In some examples, determining that dereverberation is not to be performed on the third input audio signal may be based at least in part on a classification of a media type of the third input audio signal. In some examples, a classification of the third input audio signal may be one of: 1) music; or 2) speech over music. In some examples, determining that dereverberation is not to be performed on the third input audio signal may be based at least in part on a determination that a degree of reverberation in the third input audio signal is below a threshold.

According to another aspect of the present disclosure, a method is provided for classifying an input audio signal as one of at least two media types, the method comprising: receiving an input audio signal; separating the input audio signal into two or more spatial components; and classifying each of the two or more spatial components as one of the at least two media types, wherein the media type of the input audio signal is classified by combining classifications of each of the two or more spatial components.

In some examples, the two or more spatial components comprise a center channel and a side channel, and the method further comprises: calculating a power of the side channel; and classifying the side channel in response to determining that the power of the side channel exceeds a threshold.

In some examples, the two or more spatial components comprise a diffuse component and a direct component.

In some examples, the input audio signal is separated into the two or more spatial components in response to determining that the input audio signal comprises stereo audio.

In some examples, classifying the media type of the input audio signal comprises separating the input audio signal into a vocal component and a non-vocal component. In some examples, the input audio signal is separated into the vocal component and the non-vocal component in response to determining that the input audio signal comprises a single audio channel. In some examples, classifying the media type of the input audio signal comprises: classifying the vocal component as one of: 1) speech; or 2) non-speech; classifying the non-vocal component as one of: 1) music; or 2) non-music, wherein the media type of the input audio signal is classified by combining the classification of the vocal component and the classification of the non-vocal component.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

At least some aspects of the present disclosure may be implemented via an apparatus. For example, one or more devices may be capable of performing, at least in part, the methods disclosed herein. In some implementations, an apparatus is, or includes, an audio processing system having an interface system and a control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

The present disclosure provides various technical advantages. For example, by selectively performing dereverberation on particular types of input audio signals (e.g., input audio signals classified as speech), speech intelligibility may be improved. Moreover, by inhibiting dereverberation on other types of input audio signals (e.g., input audio signals classified as music, speech over music, or the like), disadvantageous outcomes of dereverberation, such as reduced audio quality, may be avoided for audio signals for which an improvement in speech intelligibility is not needed. The technical advantages of the present disclosure may be particularly useful for user-generated content, such as podcasts.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A and 1B illustrate representations of example audio signals that include reverberation.

FIG. 2 shows a block diagram of an example system for performing dereverberation based on media type in accordance with some implementations.

FIG. 3 shows an example of a process for performing dereverberation based on media type in accordance with some implementations.

FIG. 4 shows an example of a process for spatial separation of input audio signals in accordance with some implementations.

FIG. 5 shows an example of a process for source separation of input audio signals in accordance with some implementations.

FIG. 6 shows an example of a process for determining a degree of reverberation in accordance with some implementations.

FIGS. 7A, 7B, 7C, and 7D show example graphs of two-dimensional acoustic modulation frequency spectrums of example audio signals.

FIG. 8 shows a block diagram that illustrates examples of components of an apparatus capable of implementing various aspects of this disclosure.

Like reference numbers and designations in the various drawings indicate like elements.

### DETAILED DESCRIPTION OF EMBODIMENTS

Reverberation occurs when an audio signal is distorted by various reflections off of various surfaces (e.g., walls, ceilings, floors, furniture, etc.). Reverberation may have a substantial impact on sound quality and speech intelligibility. Accordingly, dereverberation of an audio signal that includes speech may be performed to improve speech intelligibility.

Sound arriving at a receiver (e.g., a human listener, a microphone, etc.) is made up of direct sound, which includes sound directly from the source without any reflections, and reverberant sound, which includes sound reflected off of various surfaces in the environment. The reverberant sound includes early reflections and late reflections. Early reflections may reach the receiver soon after or concurrently with the direct sound, and may therefore be partially integrated into the direct sound. The integration of early reflections with direct sound creates a spectral coloration effect which contributes to a perceived sound quality. The late reflections arrive at the receiver after the early reflections (e.g., more than 50-80 milliseconds after the direct sound). The late reflections may have a detrimental effect on speech intelligibility. Accordingly, dereverberation may be performed on an audio signal to reduce an effect of late reflections present in the audio signal to thereby improve speech intelligibility.

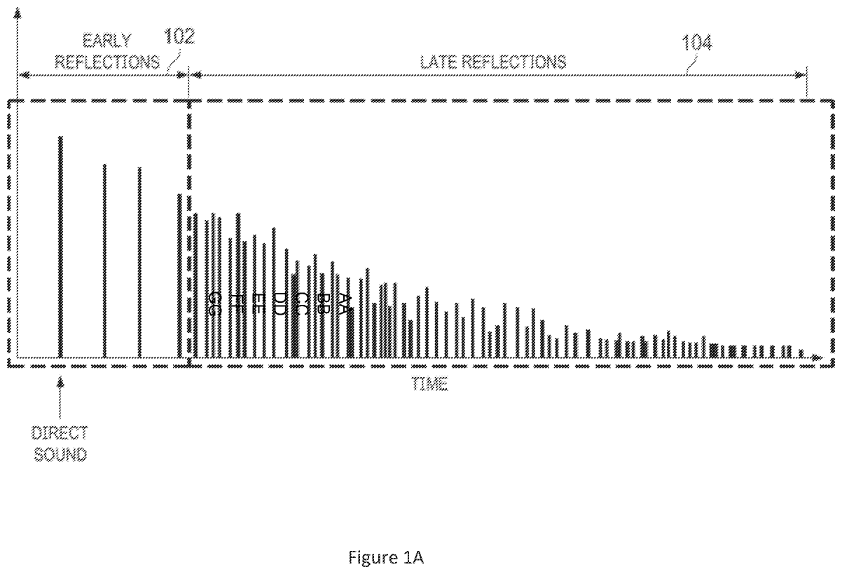

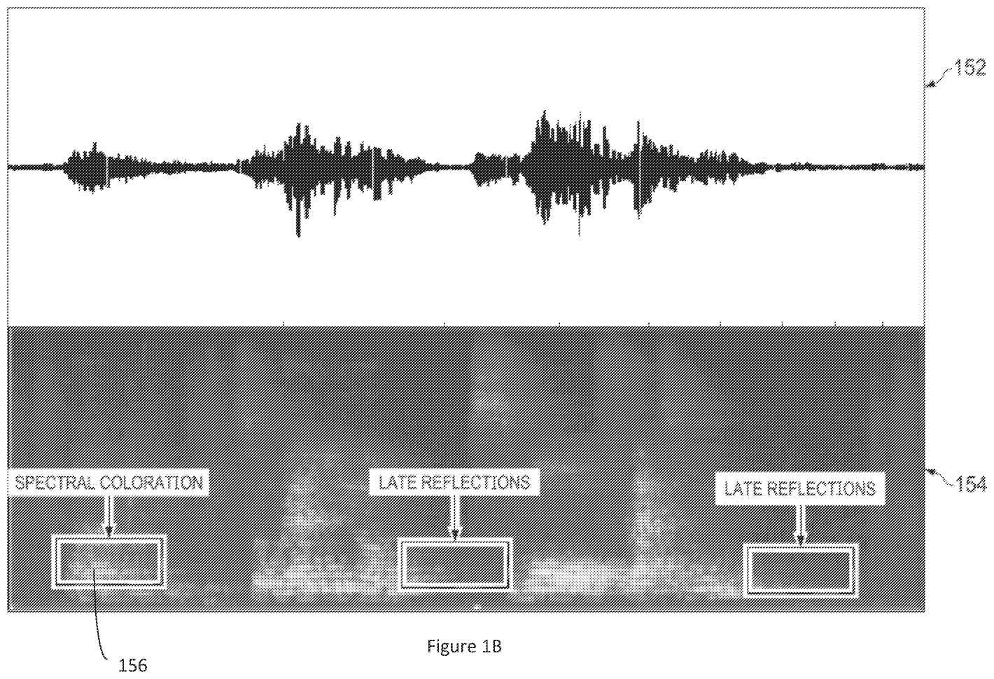

FIG. 1A shows an example of acoustic impulse responses in a reverberant environment. As illustrated, early reflections 102 may arrive at a receiver concurrently or shortly after a direct sound. By contrast, late reflections 104 may arrive at the receiver after early reflections 102.

FIG. 1B shows an example of a time domain input audio signal 152 and a corresponding spectrogram 154. As illustrated in spectrogram 154, early reflections may produce changes in spectrogram 154 as depicted by spectral colorations 156.

Dereverberation may reduce audio quality, for example, by reducing a perceived loudness, changing spectral color effects, and the like. The reduced audio quality may be particularly disadvantageous when dereverberation is performed on audio signals that primarily include music or speech over music. For example, the audio quality an audio signal that primarily includes music or speech over music may be degraded without any improvement in speech intelligibility. As a more particular example, dereverberation may be suitable for processing low-quality speech content, such as user-generated content, which is captured in far-field use cases. Continuing with this particular example, user-generated content, such as podcasts, may include both low-quality speech content and professionally-generated music content. In some cases, the professionally-generated music content may include artificial reverberation. In such cases, applying dereverberation to mixed media content (e.g., that includes low-quality speech content and professionally-generated music content with artificial reverberation) may introduce an over-suppression of reverberation that can degrade audio quality.

In some implementations, dereverberation may be performed on an input audio signal based on an identification of media type(s) associated with the input audio signal. For example, an input audio signal may be analyzed to determine if the input audio signal is: 1) speech; 2) music; 3) speech over music; or 4) other. Examples of speech over music content may include podcast intros or outros, television show intros or outros, etc.

In some implementations, dereverberation may be performed on input audio signals that are identified as being speech or as being primarily speech. Conversely, dereverberation may be inhibited on input audio signals that are identified as being music, primarily music, speech over music, or primarily speech over music. By inhibiting dereverberation for media types that are not speech or primarily speech, dereverberation may be performed on input audio signals that will substantially benefit from dereverberation (e.g., because the input audio signal primarily includes speech), while preventing a reduction in sound quality resulting from the dereverberation when such dereverberation is not needed to improve speech intelligibility.

In some implementations, an input audio signal can be classified as being one of: 1) speech; 2) music; 3) speech over music; or 4) other using various techniques. As used herein, “other” may refer to noise, sound effects, speech over sound effects, and the like. For example, in some implementations, an input audio signal may be classified by separating the input audio signal into two or more spatial components and classifying each spatial component as being one: of 1) speech; 2) music; 3) speech over music; or 4) other. Continuing with this example, in some implementations, the classification of each spatial component may then be combined to generate an aggregate classification for the input audio signal. As another example, in some implementations, an input audio signal may be classified by separating the input audio signal into a vocal component and a non-vocal component. The vocal component may be classified as one of: 1) speech; or 2) non-speech, and the non-vocal component may be classified as one of 1) music; or 2) non-music. Continuing with this example, in some implementations, the classification of each of the vocal component and the non-vocal component may then be combined to generate an aggregate classification of the input audio signal. Although the present disclosure describes several methods for classification in the context of a method for reverberation suppression, the inventive methods for classification can be used in other contexts. In particular, the present disclosure relates to a method for classifying an input audio signal as one of at least two media types, comprising: receiving an input audio signal; separating the input audio signal into two or more spatial components; and classifying each of the two or more spatial components as one of the at least two media types, wherein the media type of the input audio signal is classified by combining classifications of each of the two or more spatial components.

In some implementations, an input audio signal that has been classified as speech may be additionally analyzed to determine an amount of reverberation present in the input audio signal. In some such implementations, dereverberation may be performed on input audio signals that have been identified as having more than a threshold amount of reverberation. An amount of reverberation may be identified using a Direct to Reverberant Ratio (DRR), and/or using a Reverberation Time (RT) to 60 dB (e.g., an RT60), and/or using a diffuseness measurement, and/or other suitable measures of reverberation. Note that an amount of reverberation may be a function of DRR, where the amount of reverberation increases for decreasing values of DRR and where the amount of reverberation decreases for increasing values of DRR.

Additionally or alternatively, in some implementations, dereverberation may be performed on an input audio signal based on a classification of media type of a preceding audio signal. In some implementations, the preceding audio signal may be a preceding frame or portion of audio content that preceded the input audio signal. In some implementations, a classification of an input audio signal may be adjusted based on a classification of the preceding audio signal such that the classifications of adjacent audio signals are effectively smoothed. The adjustment may be performed based on confidence levels of each classification. Determining whether to perform dereverberation on an input audio signal based at least in part on a classification of a preceding audio signal may prevent dereverberation from being applied in a choppy manner, thereby improving overall audio quality.

In some implementations, dereverberation may be performed on an input audio signal using various techniques. For example, in some implementations, dereverberation may be performed based on amplitude modulation of the input audio signal at various frequency bands. As a more particular example, in some embodiments, a time domain audio signal can be transformed into a frequency domain signal. Continuing with this more particular example, the frequency domain signal can be divided into multiple subbands, e.g., by applying a filterbank to the frequency domain signal. Continuing further with this more particular example, amplitude modulation values can be determined for each subband, and bandpass filters can be applied to the amplitude modulation values. In some implementations, the bandpass filter values may be selected based on a cadence of human speech, e.g., such that a central frequency of a bandpass filter exceeds the cadence of human speech (e.g., in the range of 10-20 Hz, approximately 15 Hz, or the like). Continuing still further with this particular example, gains can be determined for each subband based on a function of the amplitude modulation signal values and the bandpass filtered amplitude modulation values. The gains can then be applied in each subband. In some implementations, dereverberation may be performed using the techniques described in U.S. Pat. No. 9,520,140, which is hereby incorporated by reference herein in its entirety.

As another example, in some implementations, dereverberation may be performed by estimating a dereverberated signal using a deep neural network, a weighted prediction error method, a variance-normalized delayed linear prediction method, a single-channel linear filter, a multi-channel linear filter, or the like. As yet another example, in some implementations, dereverberation may be performed by estimating a room response and performing a deconvolution operation on the input audio signal based on the room response.

It should be noted that the techniques described herein for dereverberation based on media type may be performed on various types or forms of audio content, including but not limited to: podcasts, radio shows, audio content associated with video conferences, audio content associated with television shows or movies, and the like. The audio content may be live or pre-recorded.

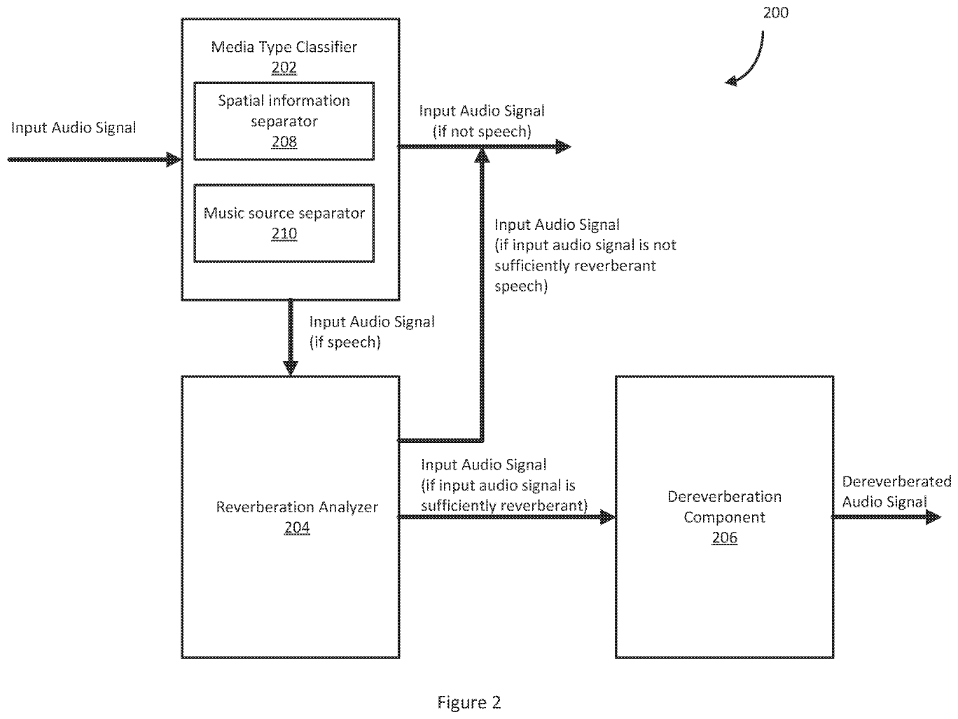

FIG. 2 shows a block diagram of an example system 200 that can be used for performing dereverberation based on an identified media type associated with an input audio signal in accordance with some implementations.

As illustrated, system 200 can include a media type classifier 202. Media type classifier 202 can receive an input audio signal. In some implementations, media type classifier 202 can classify the input audio signal as being: 1) speech; 2) music; 3) speech over music; or 4) other.

In some implementations, in response to determining that the input audio signal is not speech or is not primarily speech (e.g., determining that the input audio signal is music, speech over music, or other), media type classifier 202 can pass the input audio signal without steering the input audio signal to a reverberation analyzer 204. Conversely, in response to determining that the input audio signal is speech or is primarily speech, media type classifier 202 can pass the input audio signal to reverberation analyzer 204.

In some implementations, reverberation analyzer 204 can determine a degree of reverberation present in the input audio signal. In some implementations, reverberation analyzer 204 can determine that dereverberation is to be performed on the input audio signal in response to determining that the degree of reverberation exceeds a threshold. That is, in some implementations, reverberation analyzer 204 can further steer the input audio signal to a dereverberation component 206 in response to determining that the input audio signal is sufficiently reverberant. By contrast, in response to determining that the input audio signal is not sufficiently reverberant (e.g., that the input audio signal includes relatively “dry” speech), reverberation analyzer 204 can pass the input audio signal without steering the input audio signal to dereverberation component 206, effectively inhibiting dereverberation from being performed on the input audio signal.

Dereverberation component 206 can take, as an input, an input audio signal that has been determined to have reverberation that exceeds a threshold, and can generate a dereverberated audio signal. It should be understood that dereverberation component 206 may perform any suitable reverberation suppression technique(s).

In some implementations, media type classifier 202 classifies a media type of the input audio signal based on one or both of a spatial separation of components of the input audio signal or a music source separation of components of the input audio signal.

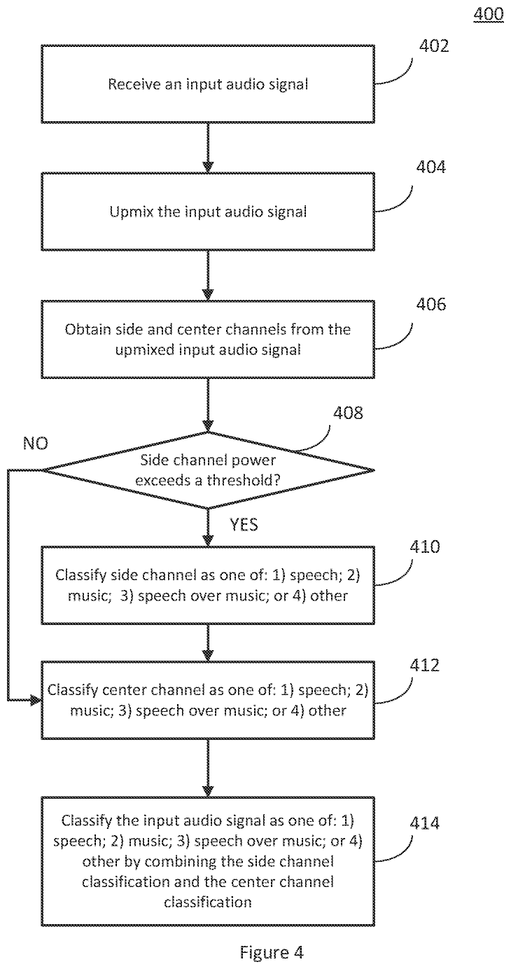

For example, in some implementations, media type classifier 202 may include a spatial information separator 208. Spatial information separator 208 may separate the input audio signal into two or more spatial components. Examples of the two or more spatial components can include a direct component and a diffuse component, a side channel and a center channel, and the like. In some implementations, spatial information separator 208 can classify a media type of the input audio signal by separately classifying each of the two or more spatial components. In some implementations, spatial information separator 208 can then generate a classification for the input audio signal by combining the classifications for each of the two or more components, e.g. by using a decision fusion algorithm. Examples of decision fusion algorithms that may be used to combine the classifications for each of the two or more components include Bayesian analysis, a Dempster-Shafer algorithm, fuzzy logic algorithms, and the like. Note that techniques for classifying media type based on spatial source separation are shown in and described below in connection with FIG. 4.

As another example, in some implementations, media type classifier 202 may include a music source separator 210. Music source separator 210 may separate the input audio signal into a vocal component and a non-vocal component. In some implementations, music source separator 210 may then classify the vocal component as one of: 1) speech; or 2) non-speech. In some implementations, music source separator 210 may classify the non-vocal component as one of: 1) music; or 2) non-music. In some implementations, music source separator 210 can generate a classification of the input audio signal as one of: 1) speech; 2) music; 3) speech over music; or 4) other based on the classifications of the vocal component and the non-vocal component. For example, in some implementations, music source separator 210 may combine the classifications of the vocal component and the non-vocal component (e.g., by using a decision fusion algorithm). Examples of decision fusion algorithms that may be used to combine the classifications for each of the two or more components include Bayesian analysis, a Dempster-Shafer algorithm, fuzzy logic algorithms, and the like.

In some implementations, media type classifier 202 may determine whether to classify a media type of an input audio signal using spatial information separator 208 or by using music source separator 210. For example, media type classifier 202 may determine that the media type is to be classified using spatial information separator 208 in response to determining that the input audio signal is a stereo audio signal. As another example, media type classifier 202 may determine that the media type is to be classified using music source separator 210 in response to determining that the input audio signal is a mono channel audio signal.

In the example of FIG. 2, media type classifier 202 is used in the context of a system 200 for performing dereverberation. It is emphasized that media type classifier 202 may be used as a stand-alone system or may be used in other audio processing systems.

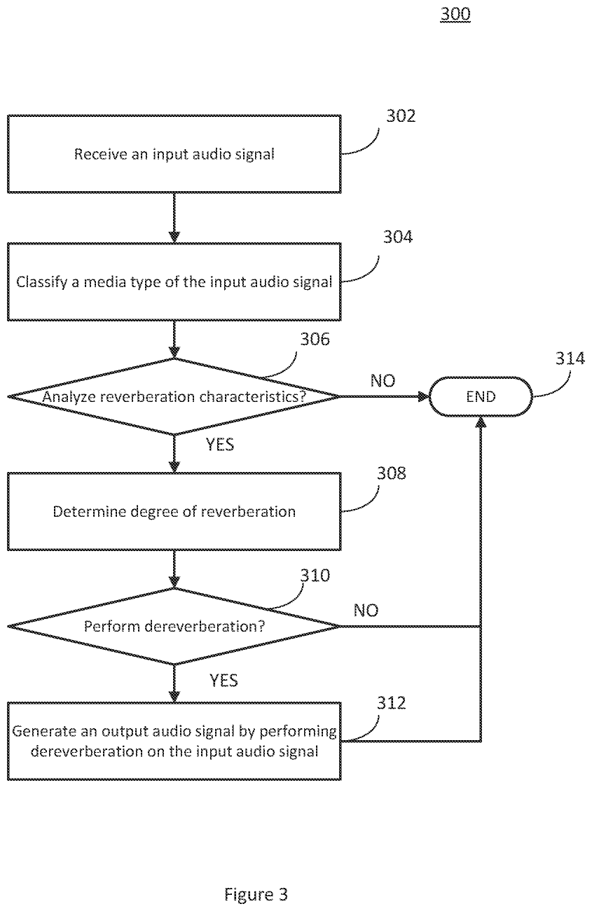

FIG. 3 shows an example of a process 300 for performing dereverberation on input audio signals based on media type classification in accordance with some implementations. In some implementations, blocks of process 300 may be performed by a device or an apparatus (e.g., apparatus 200 of FIG. 2). It should be noted that, in some implementations, blocks of process 300 may be performed in orders not shown in FIG. 3, and/or one or more blocks of process 300 may be performed substantially in parallel. Additionally, it should be noted that, in some implementations, one or more blocks of process 300 may be omitted.

At 302, process 300 can receive an input audio signal. The input audio signal may be recorded or may be live content. The input audio signal may include various types of audio content, such as speech, music, speech over music, and the like. Example types of audio content may include podcasts, radio shows, audio content associated with television shows or movies, and the like.

At 304, process 300 can classify a media type of the input audio signal. For example, in some implementations, process 300 can classify the input audio signal as being one of: 1) speech; 2) music; 3) speech over music; or 4) other.

In some implementations, process 300 may classify a media type of the input audio signal based on a separation of spatial components of the input audio signal. For example, in some implementations, process 300 may separate the input audio signal into two or more spatial components, such as a direct component and a diffuse component, a side channel and a center channel, etc. In some implementations, process 300 may then classify a media type of the audio content in each spatial component. In some implementations, process 300 may then classify the input audio signal by combining classifications of each spatial component. Note that more detailed techniques for classifying a media type of an input audio signal based on spatial separation are shown in and described below in connection with FIG. 4.

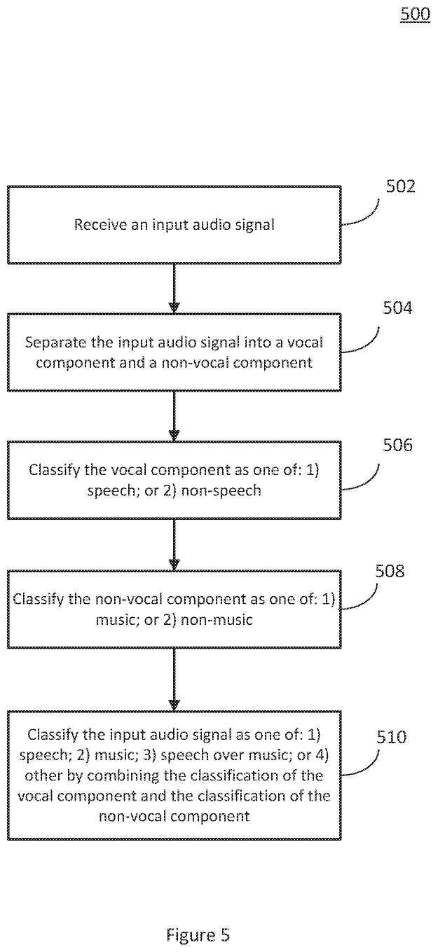

Additionally or alternatively, in some implementations, process 300 may classify a media type of the input audio signal based on a music source separation of the input audio signal. For example, in some implementations, process 300 may separate the input audio signal into a vocal component and a non-vocal component. In some implementations, process 300 may then classify a media type of the audio content in each of the vocal component and the non-vocal component. In some implementations, process 300 may then classify the input audio signal by combining classifications of each of the vocal component and the non-vocal component. Note that more detailed techniques for classifying a media type of an input audio signal based on music source separation are shown in and described below in connection with FIG. 5.

At 306, process 300 can determine whether to analyze reverberation characteristics of the input audio signal. In some implementations, process 300 can determine whether to analyze the reverberation characteristics based on the media type classification of the input audio signal determined at block 304. For example, in some implementations, process 300 can determine that the reverberation characteristics are to be analyzed (“yes” at 306) in response to determining that the media type classification of the input audio signal is speech. Conversely, in some implementations, process 300 can determine that the reverberation characteristics are not to be analyzed (“no” at 306) in response to determining that the media type classification is not speech (e.g., that the media type classification is music, speech over music, or other).

If, at 306, process 300 determines that the reverberation characteristics are not to be analyzed (“no” at 306), process 300 can end at 314.

Conversely, if, at 306, process 300 determines that the reverberation characteristics are to be analyzed (“yes” at 306), process 300 can determine a degree of reverberation in the input audio signal at 308.

In some implementations, the degree of reverberation may be calculated using an RT60 metric and/or a DRR metric associated with the input audio signal.

Additionally or alternatively, in some implementations, process 300 can determine a degree of reverberation in the input audio signal based on spectrogram information. For example, in some implementations, process 300 can determine the degree of reverberation based on energy at various modulation frequencies of the input audio signal. In particular, because non-reverberant speech may tend to have a peak in modulation frequency at a relatively low modulation frequency (e.g., 3 Hz, 4 Hz, etc.), and because reverberant speech may tend to have substantial energy at higher modulation frequencies (e.g., 10 Hz, 20 Hz, 50 Hz, etc.), process 300 may determine the degree of reverberation in the input audio signal based on an energy of the input audio signal at relatively high modulation frequencies (e.g., above 10 Hz, above 20 Hz, etc.).

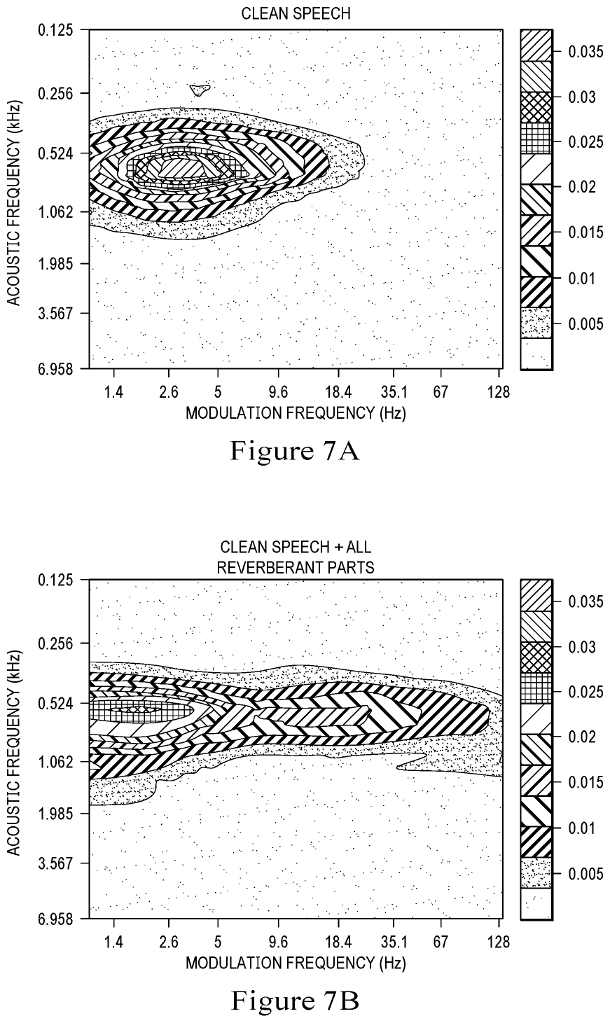

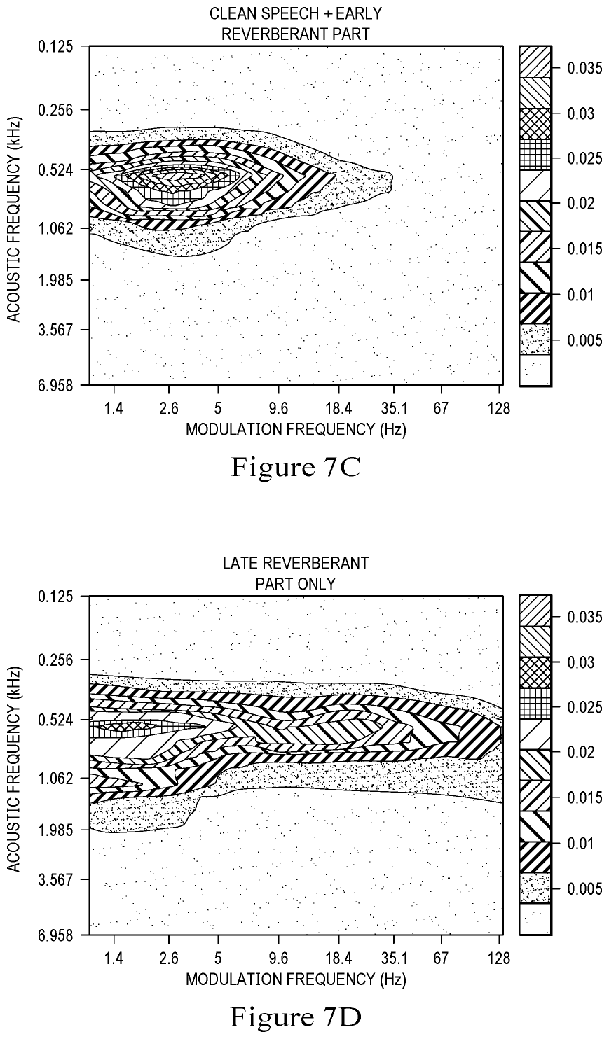

Note that more detailed techniques for determining the degree of reverberation based on spectrogram information are shown in and described below in connection with FIG. 7.

At 310, process 300 can determine whether to perform dereverberation on the input audio signal. In some implementations, process 300 can determine whether to perform dereverberation based on the degree of reverberation determined at block 308. For example, in some implementations, process 300 can determine that dereverberation is to be performed (“yes” at 310) in response to determining that the degree of reverberation exceeds a threshold. As another example, in some implementations, process 300 can determine that dereverberation is not to be performed (“no” at 310) in response to determining that the degree of reverberation is below a threshold.

In some implementations, process 300 may additionally or alternatively determine whether to perform dereverberation on the input audio signal based on a media type classification of a preceding audio signal. The preceding audio signal may correspond to a frame or portion of audio content that precedes the input audio signal. It should be noted that a frame or portion of audio content may have any suitable duration, such as 10 milliseconds, 20 milliseconds, etc.

In some implementations, process 300 may determine whether to perform dereverberation on the input audio signal based on a media type classification of the preceding audio signal by adjusting a media type classification (e.g., as determined at block 304) based on the classification of the preceding audio signal. For example, in some implementations, the media type classification of the input audio signal may be adjusted based on a confidence level of the media type classification of the input audio signal and/or based on a confidence level of the media type classification of the preceding audio signal. As a more particular example, in an instance in which the media type classification of the preceding audio signal is associated with a relatively high confidence level (e.g., greater than 70%, greater than 80%, etc.) and in which the media type classification of the input audio signal is associated with a relatively low confidence level (e.g., lower than 30%, lower than 20%, etc.), the media type classification of the input audio signal may be adjusted or modified to be the media type classification of the preceding audio signal. It should be noted that adjustment of a media type classification of an input audio signal may be performed at one or more times. For example, the media type classification may be adjusted prior to analyzing reverberation characteristics at block 306. As another example, the media type classification may be adjusted after determining a degree of reverberation at block 308.

If, at 310, process 300 determines that dereverberation is not to be performed (“no” at 310), process 300 can end at 314.

Conversely, if, at 310, process 300 determines that dereverberation is to be performed (“yes” at 310), process 300 can generate an output audio signal by performing dereverberation on the input audio signal. For example, in some implementations, dereverberation may be performed based on amplitude modulation of the input audio signal at various frequency bands. As a more particular example, dereverberation may be performed using the techniques described in U.S. Pat. No. 9,520,140, which is hereby incorporated by reference herein in its entirety. As another example, in some implementations, dereverberation may be performed by estimating a dereverberated signal using a deep neural network, a multichannel linear filter, or the like. As yet another example, in some implementations, dereverberation may be performed by estimating a room response and performing a deconvolution operation on the input audio signal based on the room response.

Process 300 can then end at 314.

It should be noted that, after ending at 314, an output audio signal can be presented, for example, via speakers, headphones, etc. In some implementations, in instances in which dereverberation of block 312 was not performed (e.g., because the input audio signal was classified as being music, speech over music, or other non-speech content), the output audio signal may be the original input audio signal. Alternatively, in some implementations, in instances in which dereverberation of block 312 was not performed (e.g., because the input audio signal was classified as being speech, speech over music, or other non-speech content), a different dereverberation technique other than what is applied at 312 may be applied to the original input audio signal.

In some implementations, in instances in which dereverberation is performed at block 312, the output audio signal may correspond to the dereverberated input audio signal.

In some implementations, a media type of an input audio signal may be classified based on spatial separation of components of the input audio signal. Example components include a direct component and a diffuse component, a center channel and a side channel, and the like. In some implementations, each spatial component may be classified as one of: 1) speech; 2) music; 3) speech over music; or 4) other. In some implementations, the input audio signal may be classified based on a combination of the classification of each of the spatial components. In some implementations, two or more spatial components may be identified based on an upmixing of the input audio signal. In some implementations, media type classification of an input audio signal based on spatial separation of components of the input audio signal may be performed in response to determining that the input audio signal is a multichannel audio signal (e.g., a stereo audio signal, a 5.1 audio signal, a 7.1 audio signal, and the like).

FIG. 4 shows an example of a process 400 for classifying a media type of an input audio signal based on spatial separation of components of the input audio signal in accordance with some implementations. It should be noted that blocks of process 400 may be performed in various orders not shown in FIG. 4, and/or in some implementations, two or more blocks of process 400 may be performed substantially in parallel. Additionally or alternatively, it should be noted that in some implementations, one or more blocks of process 400 may be omitted.

Process 400 can begin at 402 by receiving an input audio signal. In some implementations, the input audio signal may include two or more audio channels.

At 404, process 400 can upmix the input audio signal to increase a number of audio channels associated with the input audio signal. Process 400 can use various types of upmixing. For example, in some implementations, process 400 can perform an upmixing technique such as Left/Right to Mid/Side shuffling. As another example, in some implementations process 400 can perform an upmixing technique that transforms a stereo audio input into a multichannel content, such as 5.1, 7.1, and the like.

In some implementations, the input audio signal can be split into a direct component and a diffuse component. For example, in some implementations, the direct component and the diffuse component can be identified based on inter-channel coherence. As a more particular example, in some implementations, the direct component and the diffuse component can be identified based on coherence matrix analysis.

At 406, process 400 can obtain side and center channels from the upmixed input audio signals. For example, in an instance in which the upmixed input audio signal correspond to shuffled Mid/Side channels, the side channel can correspond to the shuffled side channel, and the center channel can correspond to the shuffled mid channel. As another example, in an instance in which the upmixed input audio signal correspond to a multichannel upmixing (e.g., 5.1, 7.1, etc.), the center channel can be taken directly from the upmixed audio signal, and the side channel can be obtained by downmixing a left/right pair (e.g., Left/Right, Left Surround/Right Surround, etc.).

In an instance in which the input audio signal was split into a direct component and a diffuse component, the center channel can correspond to the direct component and the side channel can correspond to the diffuse component.

At 408, process 400 can determine whether a power in the side channel exceeds a threshold. Examples of thresholds can be −65 dB relative to full scale (dBFS), −68 dBFS, −70 dBFS, −72 dBFS, or the like.

If, at 408, it is determined that the power in the side channel does not exceed the threshold (“no” at 408), process 400 can proceed to block 412.

Conversely, if, at 408, it is determined that the power in the side channel exceeds the threshold (“yes” at 408), process 400 can classify the side channel as one of: 1) speech; 2) music; 3) speech over music; or 4) other at 410. In some implementations, the classification of the side channel may be associated with a confidence level. Examples of classifiers that may be used to classify the side channel include k-nearest neighbor, case-based reasoning, decision trees, Naïve Bayes, and/or various types of neural networks (e.g., a Convolutional Neural Network (CNN), and the like).

At 412, process 400 can classify the center channel as one of: 1) speech, 2) music; 3) speech over music; or 4) other. In some implementations, the classification of the center channel may be associated with a confidence level. Examples of classifiers that may be used to classify the center channel include k-nearest neighbor, case-based reasoning, decision trees, Naïve Bayes, and/or various types of neural networks (e.g., a Convolutional Neural Network (CNN), and the like).

At 414, process 400 can classify the input audio signal as one of: 1) speech; 2) music; 3) speech over music; or 4) other by combining the side channel classification (if it exists) with the center channel classification.

For example, in some implementations, the side channel classification and the center channel classification can be combined using a decision fusion algorithm. Examples of decision fusion algorithms that may be used to combine the classifications for each of the two or more components include a Bayesian analysis, a Dempster-Shafer algorithm, fuzzy logic algorithms, and the like.

As another example, in some implementations, in response to the side channel being classified as music, speech over music, or other, the input audio signal can be classified as “not speech,” regardless of a classification of the center channel. As a more particular example, in an instance in which the center channel is classified as “speech” and in which the side channel is classified as “music,” the input audio signal may be classified as speech over music.

As yet another example, in some implementations, the side channel classification and the center channel classification may be combined based on the confidence levels associated with the side channel classification and the center channel classification, respectively. As a more particular example, in some implementations, the side channel classification and the center channel classification may be combined such that the classification of the spatial component associated with the higher confidence level is weighted more in the combination. As a specific example, in an instance in which the center channel is classified as “speech” with a relatively high confidence level (e.g., more than 70%, more than 80%, etc.), and in which the side channel is classified as “music,” “speech over music,” or “other” with a relatively low confidence level (e.g., less than 30%, less than 20%, etc.), the input audio signal may be classified as speech. As another specific example, in an instance in which the center channel is classified as “speech” with a relatively low confidence level (e.g., less than 30%, less than 20%, etc.), and in which the side channel is classified as “music,” “speech over music,” or “other” with a relatively high confidence level (e.g., more than 70%, more than 80%, etc.), the input audio signal can be classified as “speech over music” or “other.”

It should be noted that in an instance in which the side channel was not classified (e.g., because the power in the side channel was below the threshold as determined at block 408), the classification of the input audio signal may correspond to the classification of the center channel.

In some implementations, an input audio signal may be classified based on a music source separation of the input audio signal into a vocal component and a non-vocal component. The vocal component may then be classified as speech or non-speech, and the non-vocal component may be classified as music or non-music. In some implementations, the input audio signal may then be classified as one of: 1) speech; 2) music; 3) speech over music; or 4) other based on a combination of the classifications of the vocal component and the non-vocal component. In some implementations, an input audio signal may be classified using music source separation of the input audio signal in response to determining that the input audio signal is a mono channel audio signal. Alternatively, in some implementations, an input audio signal may be classified using music source separation in addition to classification of the input audio signal based on a spatial separation of components.

FIG. 5 shows an example of a process 500 for classifying an input audio signal based on music source separation in accordance with some implementations. It should be noted that blocks of process 500 may be performed in various orders not shown in FIG. 5, and/or in some implementations, two or more blocks of process 500 may be performed substantially in parallel. Additionally or alternatively, it should be noted that in some implementations, one or more blocks of process 500 may be omitted.

Process 500 can begin at 502 by receiving an input audio signal. In some implementations, the input audio signal may be a single-channel audio signal.

At 504, process 500 can separate the input audio signal into a vocal component and a non-vocal component. In some implementations, the vocal component and the non-vocal component can be identified using one or more trained machine learning models. Example types of machine learning models that may be used to separate the input audio signal into the vocal component and the non-vocal component may include a Deep Neural Network (DNN), a Convolutional Neural Network (CNN), a Long Short-Term Memory (LSTM) network, Convolutional Recurrent Neural Network (CRNN), Gated Recurrent Unit (GRU), Convolutional Gated Recurrent Unit (CGRU), and the like.

At 506, process 500 can classify the vocal component as one of: 1) speech; or 2) non-speech. In some implementations, the classification of the vocal component may be associated with a confidence level. Examples of classifiers that may be used to classify the vocal component include k-nearest neighbor, case-based reasoning, decision trees, Naïve Bayes, and/or various types of neural networks (e.g., a Convolutional Neural Network (CNN), and the like).

At 508, process 500 can classify the non-vocal component as one of: 1) music; and 2) non-music. In some implementations, the classification of the non-vocal component may be associated with a confidence level. Examples of classifiers that may be used to classify the non-vocal component include k-nearest neighbor, case-based reasoning, decision trees, Naïve Bayes, and/or various types of neural networks (e.g., a Convolutional Neural Network (CNN), and the like).

At 510, process 500 can classify the input audio signal as one of: 1) speech; 2) music; 3) speech over music; or 4) other by combining the classification of the vocal component and the classification of the non-vocal component. For example, in some implementations, the classification of the vocal component may be combined with the classification of the non-vocal component using any suitable decision fusion algorithm(s) that combine classifications from two classifiers to generate an aggregate classification of the input audio signal. Examples of decision fusion algorithms that may be used to combine the classifications for each of the two or more components include Bayesian, Dempster-Shafer, fuzzy logic algorithms, and the like.

As another example, in some implementations, the classification of the vocal component may be combined with the classification of the non-vocal component based on the confidence levels of the classification of the vocal component and the classification of the non-vocal component, respectively. As a more particular example, in some implementations, the classification of the vocal component and the classification of the non-vocal component may be combined such that the component associated with a higher confidence level is weighted more in the combination.

In some implementations, an amount of reverberation present in an input audio signal can be determined. In some implementations, the amount of reverberation may be calculated using the DRR. For example, in some implementations, the amount of reverberation may be inversely related to the DRR such that the amount of reverberation is increasing for decreasing values of DRR and such that the amount of reverberation is decreasing for increasing values of DRR. In some implementations, the amount of reverberation may be calculated using a duration of time required for a sound pressure level to decrease by a fixed amount (e.g., 60 dB). For example, the amount of reverberation may be calculated using an RT60, which indicates a time for the sound pressure level to decrease by 60 dB. In some implementations, a DRR or an RT60 associated with the input audio signal may be estimated using various algorithms or techniques, which may be signal-processing based and/or machine learning model based.

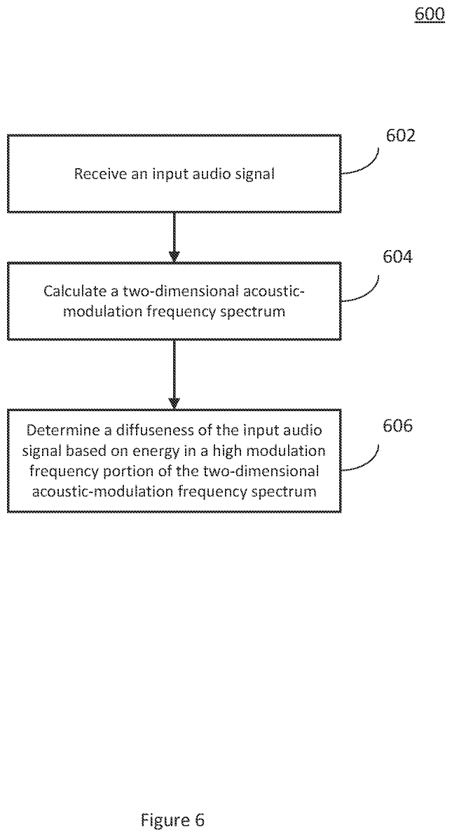

In some implementations, the amount of reverberation in the input audio signal may be calculated by estimating a diffuseness of the input audio signal. FIG. 6 shows an example of a process 600 for estimating a diffuseness of an input audio signal in accordance with some implementations. It should be noted that blocks of process 600 may be performed in various orders not shown in FIG. 6, and/or in some implementations, two or more blocks of process 600 may be performed substantially in parallel. Additionally or alternatively, it should be noted that in some implementations, one or more blocks of process 600 may be omitted.

It should be noted that, in some implementations, an amount of reverberation may be determined based on a combination of multiple metrics. The multiple metrics may include, for example, DRR, RT60, a diffuseness estimate, or the like. In some implementations, multiple metrics may be combined using various techniques, such as a weighted average. In some implementations one or more metrics may be scaled or normalized.

Process 600 can begin at 602 by receiving an input audio signal.

At 604, process 600 can calculate a two-dimensional acoustic modulation frequency spectrum of the input audio signal. The two-dimensional acoustic modulation frequency spectrum can indicate an energy present in the input audio signal as a function of acoustic frequency and modulation frequency.

At 606, process 600 can determine a degree of diffuseness of the input audio signal based on energy in a high modulation frequency portion (e.g., for modulation frequencies greater than 6 Hz, greater than 10 Hz, etc.) of the two-dimensional acoustic-modulation frequency spectrum. For example, in some implementations, process 600 can calculate a ratio of the energy in the high modulation frequency portion to the energy across all modulation frequencies. As another example, in some implementations, process 600 can calculate a ratio of the energy in the high modulation frequency portion to energy in a low modulation frequency portion (e.g., for modulation frequencies below 10 Hz, below 20 Hz, etc.)

FIGS. 7A, 7B, 7C, and 7D, show examples of two-dimensional acoustic modulation frequency spectrums for various types of input speech signals. As illustrated, each two-dimensional acoustic modulation frequency shows an energy present in the input signal as a function of acoustic frequency (as indicated in the y-axis of each spectrum shown in FIGS. 7A, 7B, 7C, and 7D) and modulation frequency (as indicated in the x-axis of each spectrum shown in FIGS. 7A, 7B, 7C, and 7D).

As shown in FIG. 7A, “clean” speech, that has little or no reverberation, may have a two-dimensional acoustic modulation frequency spectrum in which most energy is concentrated at relatively low modulation frequencies (e.g., less than 5 Hz, less than 10 Hz, etc.).

As shown in FIG. 7B, an input signal that includes both clean speech and early and late reverberance reflections may have a two-dimensional acoustic modulation frequency spectrum in which energy is spread across all modulation frequencies.

As shown in FIG. 7C, an input signal that includes both clean speech and early reverberance reflections may have a two-dimensional acoustic modulation frequency spectrum in which energy is generally concentrated at relatively low modulation frequencies (e.g., less than 5 Hz, less than 10 Hz). In other words, the two-dimensional acoustic modulation frequency for an input signal that includes clean speech and early reverberance reflections (but without late reverberance reflections) may be substantially similar to a two-dimensional acoustic modulation frequency spectrum of clean speech alone.

As shown in FIG. 7D, an input signal that includes the late reverberant reflections without clean speech or early reverberant reflections may have a two-dimensional acoustic modulation frequency spectrum in which energy is spread across all modulation frequencies.

Accordingly, as illustrated by FIGS. 7A, 7B, 7C, and 7D, a diffuseness estimate may be calculated based on a ration between the amount of energy at relatively high modulation frequencies and the overall energy or based on the relative ratio between the energy at relatively high modulation frequencies and the energy at relatively low modulation frequencies.

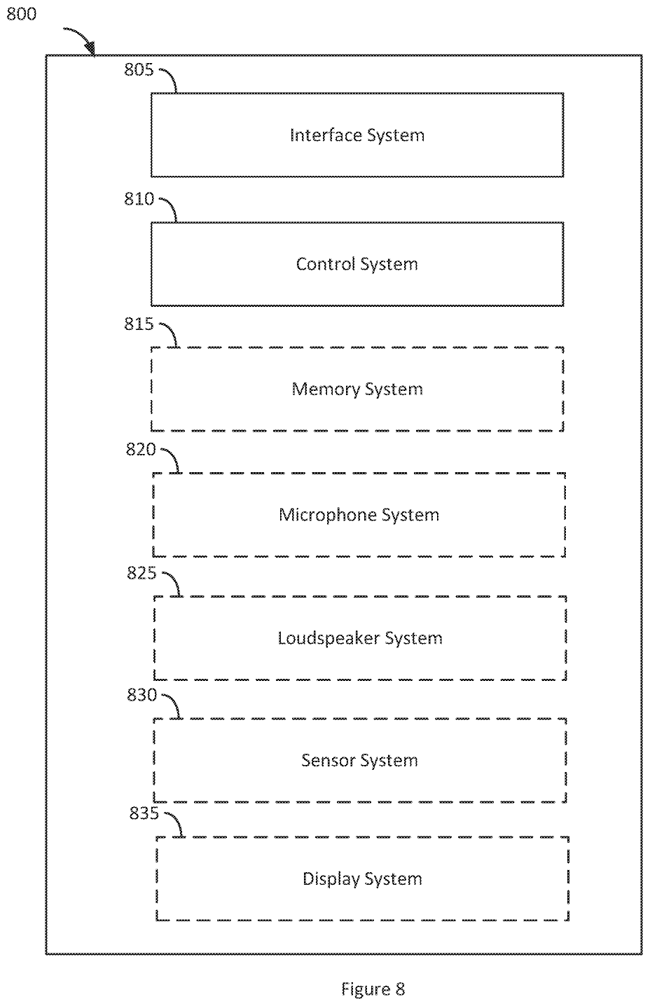

FIG. 8 is a block diagram that shows examples of components of an apparatus capable of implementing various aspects of this disclosure. As with other figures provided herein, the types and numbers of elements shown in FIG. 8 are merely provided by way of example. Other implementations may include more, fewer and/or different types and numbers of elements. According to some examples, the apparatus 800 may be configured for performing at least some of the methods disclosed herein. In some implementations, the apparatus 800 may be, or may include, a television, one or more components of an audio system, a mobile device (such as a cellular telephone), a laptop computer, a tablet device, a smart speaker, or another type of device.

According to some alternative implementations the apparatus 800 may be, or may include, a server. In some such examples, the apparatus 800 may be, or may include, an encoder. Accordingly, in some instances the apparatus 800 may be a device that is configured for use within an audio environment, such as a home audio environment, whereas in other instances the apparatus 800 may be a device that is configured for use in “the cloud,” e.g., a server.

In this example, the apparatus 800 includes an interface system 805 and a control system 810. The interface system 805 may, in some implementations, be configured for communication with one or more other devices of an audio environment. The audio environment may, in some examples, be a home audio environment. In other examples, the audio environment may be another type of environment, such as an office environment, an automobile environment, a train environment, a street or sidewalk environment, a park environment, etc. The interface system 805 may, in some implementations, be configured for exchanging control information and associated data with audio devices of the audio environment. The control information and associated data may, in some examples, pertain to one or more software applications that the apparatus 800 is executing.

The interface system 805 may, in some implementations, be configured for receiving, or for providing, a content stream. The content stream may include audio data. The audio data may include, but may not be limited to, audio signals. In some instances, the audio data may include spatial data, such as channel data and/or spatial metadata. In some examples, the content stream may include video data and audio data corresponding to the video data.

The interface system 805 may include one or more network interfaces and/or one or more external device interfaces (such as one or more universal serial bus (USB) interfaces). According to some implementations, the interface system 805 may include one or more wireless interfaces. The interface system 805 may include one or more devices for implementing a user interface, such as one or more microphones, one or more speakers, a display system, a touch sensor system and/or a gesture sensor system. In some examples, the interface system 805 may include one or more interfaces between the control system 810 and a memory system, such as the optional memory system 815 shown in FIG. 8. However, the control system 810 may include a memory system in some instances. The interface system 805 may, in some implementations, be configured for receiving input from one or more microphones in an environment.

The control system 810 may, for example, include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 810 may reside in more than one device. For example, in some implementations a portion of the control system 810 may reside in a device within one of the environments depicted herein and another portion of the control system 810 may reside in a device that is outside the environment, such as a server, a mobile device (e.g., a smartphone or a tablet computer), etc. In other examples, a portion of the control system 810 may reside in a device within one environment and another portion of the control system 810 may reside in one or more other devices of the environment. For example, control system functionality may be distributed across multiple smart audio devices of an environment, or may be shared by an orchestrating device (such as what may be referred to herein as a smart home hub) and one or more other devices of the environment. In other examples, a portion of the control system 810 may reside in a device that is implementing a cloud-based service, such as a server, and another portion of the control system 810 may reside in another device that is implementing the cloud-based service, such as another server, a memory device, etc. The interface system 805 also may, in some examples, reside in more than one device.

In some implementations, the control system 810 may be configured for performing, at least in part, the methods disclosed herein. According to some examples, the control system 810 may be configured for implementing methods of dereverberation based on media type classification.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 815 shown in FIG. 8 and/or in the control system 810. Accordingly, various innovative aspects of the subject matter described in this disclosure can be implemented in one or more non-transitory media having software stored thereon. The software may, for example, include instructions for controlling at least one device to classify media type of audio content, determine a degree of reverberation, determine whether dereverberation is to be performed, perform dereverberation on an audio signal, etc. The software may, for example, be executable by one or more components of a control system such as the control system 810 of FIG. 8.

In some examples, the apparatus 800 may include the optional microphone system 820 shown in FIG. 8. The optional microphone system 820 may include one or more microphones. In some implementations, one or more of the microphones may be part of, or associated with, another device, such as a speaker of the speaker system, a smart audio device, etc. In some examples, the apparatus 800 may not include a microphone system 820. However, in some such implementations the apparatus 800 may nonetheless be configured to receive microphone data for one or more microphones in an audio environment via the interface system 810. In some such implementations, a cloud-based implementation of the apparatus 800 may be configured to receive microphone data, or a noise metric corresponding at least in part to the microphone data, from one or more microphones in an audio environment via the interface system 810.

According to some implementations, the apparatus 800 may include the optional loudspeaker system 825 shown in FIG. 8. The optional loudspeaker system 825 may include one or more loudspeakers, which also may be referred to herein as “speakers” or, more generally, as “audio reproduction transducers.” In some examples (e.g., cloud-based implementations), the apparatus 800 may not include a loudspeaker system 825. In some implementations, the apparatus 800 may include headphones. Headphones may be connected or coupled to the apparatus 800 via a headphone jack or via a wireless connection (e.g., BLUETOOTH).

In some implementations, the apparatus 800 may include the optional sensor system 830 shown in FIG. 8. The optional sensor system 830 may include one or more touch sensors, gesture sensors, motion detectors, etc. According to some implementations, the optional sensor system 830 may include one or more cameras. In some implementations, the cameras may be free-standing cameras. In some examples, one or more cameras of the optional sensor system 830 may reside in an audio device, which may be a single purpose audio device or a virtual assistant. In some such examples, one or more cameras of the optional sensor system 830 may reside in a television, a mobile phone or a smart speaker. In some examples, the apparatus 800 may not include a sensor system 830. However, in some such implementations the apparatus 800 may nonetheless be configured to receive sensor data for one or more sensors in an audio environment via the interface system 810.

In some implementations, the apparatus 800 may include the optional display system 835 shown in FIG. 8. The optional display system 835 may include one or more displays, such as one or more light-emitting diode (LED) displays. In some instances, the optional display system 835 may include one or more organic light-emitting diode (OLED) displays. In some examples, the optional display system 835 may include one or more displays of a television. In other examples, the optional display system 835 may include a laptop display, a mobile device display, or another type of display. In some examples wherein the apparatus 800 includes the display system 835, the sensor system 830 may include a touch sensor system and/or a gesture sensor system proximate one or more displays of the display system 835. According to some such implementations, the control system 810 may be configured for controlling the display system 835 to present one or more graphical user interfaces (GUIs).

According to some such examples the apparatus 800 may be, or may include, a smart audio device. In some such implementations the apparatus 800 may be, or may include, a wakeword detector. For example, the apparatus 800 may be, or may include, a virtual assistant.

Some aspects of present disclosure include a system or device configured (e.g., programmed) to perform one or more examples of the disclosed methods, and a tangible computer readable medium (e.g., a disc) which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor (e.g., a personal computer (PC) or other computer system or microprocessor, which may include an input device and a memory) which is programmed with software or firmware and/or otherwise configured to perform any of a variety of operations including one or more examples of the disclosed methods. Alternatively, elements of some embodiments of the inventive system are implemented as a general purpose processor or DSP configured (e.g., programmed) to perform one or more examples of the disclosed methods, and the system also includes other elements (e.g., one or more loudspeakers and/or one or more microphones). A general purpose processor configured to perform one or more examples of the disclosed methods may be coupled to an input device (e.g., a mouse and/or a keyboard), a memory, and a display device.

Another aspect of present disclosure is a computer readable medium (for example, a disc or other tangible storage medium) which stores code for performing (e.g., coder executable to perform) one or more examples of the disclosed methods or steps thereof.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

Various aspects of the present invention may be appreciated from the following enumerated example embodiments (EEEs):
EEE1. A method for reverberation suppression, comprising:
   receiving an input audio signal;
      classifying a media type of the input audio signal as one of a group comprising at least: 1) speech; 2) music; or 3) speech over music;
      determining whether to perform dereverberation on the input audio signal based at least on a determination that the media type of the input audio signal has been classified as speech; and
      in response to determining that dereverberation is to be performed on the input audio signal, generating an output audio signal by performing dereverberation on the input audio signal.
EEE2. The method of EEE 1, further comprising determining a degree of reverberation in the input audio signal, wherein determining whether to perform dereverberation on the input audio signal is based on the degree of reverberation.
EEE3. The method of EEE 2, wherein the degree of reverberation is based on a reverberation time (RT60), a Direct-to-Reverberant Ratio (DRR), an estimation of diffuseness, or any combination thereof.
EEE4. The method of EEE 3, wherein determining the degree of reverberation comprises: calculating a two-dimensional acoustic-modulation frequency spectrum of the input audio signal, wherein the degree of reverberation is based on an amount of energy in a high modulation frequency portion of the two-dimensional acoustic-modulation frequency spectrum.
EEE5. The method of EEE 4, wherein determining the degree of reverberation comprises calculating at least one of: 1) a ratio of energy in a high modulation frequency portion of the two-dimensional acoustic-modulation frequency spectrum to energy over all modulation frequencies in the two-dimensional acoustic-modulation frequency spectrum; or 2) a ratio of energy in the high modulation frequency portion of the two-dimensional acoustic-modulation frequency spectrum to energy in a low-modulation frequency portion of the two-dimensional acoustic-modulation frequency spectrum.
EEE6. The method of EEEs 4 or 5, wherein determining whether to perform dereverberation on the input audio signal is based on a determination that the degree of reverberation exceeds a threshold.
EEE7. The method of any one of EEEs 1-6, wherein classifying the media type of the input audio signal comprises separating the input audio signal into two or more spatial components.
EEE8. The method of EEE 7, wherein the two or more spatial components comprise a center channel and a side channel.
EEE9. The method of EEE 8, further comprising:
calculating a power of the side channel; and
   classifying the side channel in response to determining that the power of the side channel exceeds a threshold.
EEE10. The method of EEE 7, wherein the two or more spatial components comprise a diffuse component and a direct component.
EEE11. The method of any one of EEEs 7-10, wherein classifying the media type of the input audio signal comprises classifying each of the two or more spatial components as one of: 1) speech; 2) music; or 3) speech over music, wherein the media type of the input audio signal is classified by combining classifications of each of the two or more spatial components.
EEE12. The method of any one of EEEs 7-11, wherein the input audio signal is separated into the two or more spatial components in response to determining that the input audio signal comprises stereo audio.
EEE13. The method of any one of EEEs 1-6, wherein classifying the media type of the input audio signal comprises separating the input audio signal into a vocal component and a non-vocal component.
EEE14. The method of EEE 13, wherein the input audio signal is separated into the vocal component and the non-vocal component in response to determining that the input audio signal comprises a single audio channel.
EEE15. The method of EEE 13 or 14, wherein classifying the media type of the input audio signal comprises:
   classifying the vocal component as one of: 1) speech; or 2) non-speech;
   classifying the non-vocal component as one of: 1) music; or 2) non-music,
   wherein the media type of the input audio signal is classified by combining the classification of the vocal component and the classification of the non-vocal component.
EEE16. The method of any one of EEEs 1-15, wherein determining whether to perform dereverberation on the input audio signal is based on a classification of a second input audio signal that preceded the input audio signal.
EEE17. The method of any one of EEEs 1-16, further comprising:
receiving a third input audio signal;
   determining that dereverberation is not to be performed on the third input audio signal; and
   in response to determining that dereverberation is not to be performed on the third input audio signal, inhibiting a dereverberation algorithm from being performed on the third input audio signal.
EEE18. The method of EEE 17, wherein determining that dereverberation is not to be performed on the third input audio signal is based at least in part on a classification of a media type of the third input audio signal.
EEE19. The method of EEE 18, wherein the classification of the media type of the third input audio signal is one of: 1) music; or 2) speech over music.
EEE20. The method of any one of EEEs 17-19, wherein determining that dereverberation is not to be performed on the third input audio signal is based at least in part on a determination that a degree of reverberation in the third input audio signal is below a threshold.
EEE21. An apparatus configured for implementing the method of any one of EEEs 1-20.
EEE22. A system configured for implementing the method of any one of EEEs 1-20.
EEE23. One or more non-transitory media having software stored thereon, the software including instructions for controlling one or more devices to perform the method of any one of EEEs 1-20.
EEE24. A method for classifying an input audio signal as one of at least two media types, comprising:
   receiving an input audio signal;
   separating the input audio signal into two or more spatial components; and
   classifying each of the two or more spatial components as one of the at least two media types,
wherein the media type of the input audio signal is classified by combining classifications of each of the two or more spatial components.
EEE25. The method of EEE 24, wherein the two or more spatial components comprise a center channel and a side channel, the method further comprising:
   calculating a power of the side channel; and
   classifying the side channel in response to determining that the power of the side channel exceeds a threshold.
EEE26. The method of EEE 24, wherein the two or more spatial components comprise a diffuse component and a direct component.
EEE27. The method of any one of EEEs 24-26, wherein the input audio signal is separated into the two or more spatial components in response to determining that the input audio signal comprises stereo audio.
EEE28. The method of any one of EEEs 24-26, wherein classifying the media type of the input audio signal comprises separating the input audio signal into a vocal component and a non-vocal component.
EEE29. The method of EEE 28, wherein the input audio signal is separated into the vocal component and the non-vocal component in response to determining that the input audio signal comprises a single audio channel.
EEE30. The method of EEE 28 or 29, wherein classifying the media type of the input audio signal comprises:
   classifying the vocal component as one of: 1) speech; or 2) non-speech;
   classifying the non-vocal component as one of: 1) music; or 2) non-music,
   wherein the media type of the input audio signal is classified by combining the classification of the vocal component and the classification of the non-vocal component.
EEE31. A system configured for implementing the method of any one of EEEs 24-30.
EEE32. One or more non-transitory media having software stored thereon, the software including instructions for controlling one or more devices to perform the method of any one of EEEs 24-30.

What is claimed:

1. A method for reverberation suppression, comprising:
receiving an input audio signal;
classifying a media type of the input audio signal as one of a group comprising at least: 1) speech; 2) music; or 3) speech over music;
determining whether to perform dereverberation on the input audio signal based at least on a determination that the media type of the input audio signal has been classified as speech; and
in response to determining that dereverberation is to be performed on the input audio signal, generating an output audio signal by performing dereverberation on the input audio signal.

2. The method of claim 1, further comprising determining a degree of reverberation in the input audio signal, wherein determining whether to perform dereverberation on the input audio signal is based on the degree of reverberation, and optionally wherein the degree of reverberation is based on a reverberation time (RT60), a Direct-to-Reverberant Ratio (DRR), an estimation of diffuseness, or any combination thereof.

3. The method of claim 2, wherein determining the degree of reverberation comprises:
calculating a two-dimensional acoustic-modulation frequency spectrum of the input audio signal, wherein the degree of reverberation is based on an amount of energy in a high modulation frequency portion of the two-dimensional acoustic-modulation frequency spectrum, and optionally,
wherein determining the degree of reverberation comprises calculating at least one of: 1) a ratio of energy in a high modulation frequency portion of the two-dimensional acoustic-modulation frequency spectrum to energy over all modulation frequencies in the two-dimensional acoustic-modulation frequency spectrum; or 2) a ratio of energy in the high modulation frequency portion of the two-dimensional acoustic-modulation frequency spectrum to energy in a low-modulation frequency portion of the two-dimensional acoustic-modulation frequency spectrum.

4. The method of claim 2, wherein determining whether to perform dereverberation on the input audio signal is based on a determination that the degree of reverberation exceeds a threshold.

5. The method of claim 1, wherein classifying the media type of the input audio signal comprises separating the input audio signal into two or more spatial components, and optionally wherein the input audio signal is separated into the two or more spatial components in response to determining that the input audio signal comprises stereo audio.

6. The method of claim 5, wherein the two or more spatial components comprise a center channel and a side channel, and optionally wherein the method further comprises:
calculating a power of the side channel; and
classifying the side channel in response to determining that the power of the side channel exceeds a threshold.

7. The method of claim 5, wherein the two or more spatial components comprise a diffuse component and a direct component.

8. The method of claim 5, wherein classifying the media type of the input audio signal comprises classifying each of the two or more spatial components as one of: 1) speech; 2) music; or 3) speech over music, wherein the media type of the input audio signal is classified by combining classifications of each of the two or more spatial components.

9. The method of claim 1, wherein classifying the media type of the input audio signal comprises separating the input audio signal into a vocal component and a non-vocal component, and optionally wherein the input audio signal is separated into the vocal component and the non-vocal component in response to determining that the input audio signal comprises a single audio channel.

10. The method of claim 9, wherein classifying the media type of the input audio signal comprises:
classifying the vocal component as one of: 1) speech; or 2) non-speech;
classifying the non-vocal component as one of: 1) music; or 2) non-music,
wherein the media type of the input audio signal is classified by combining the classification of the vocal component and the classification of the non-vocal component.

11. The method of claim 1, wherein determining whether to perform dereverberation on the input audio signal is based on a classification of a second input audio signal that preceded the input audio signal.

12. The method of claim 1, further comprising:
receiving a third input audio signal;
determining that dereverberation is not to be performed on the third input audio signal; and
in response to determining that dereverberation is not to be performed on the third input audio signal, inhibiting a dereverberation algorithm from being performed on the third input audio signal, and optionally wherein determining that dereverberation is not to be performed on the third input audio signal is based at least in part on: (a) a classification of a media type of the third input audio signal or (b) a determination that a degree of reverberation in the third input audio signal is below a threshold, wherein the classification of the media type of the third input audio signal is one of: 1) music; or 2) speech over music.

13. A method for classifying an input audio signal as one of at least two media types, comprising:
receiving an input audio signal;
separating the input audio signal into two or more spatial components; and
classifying each of the two or more spatial components as one of the at least two media types,
wherein the media type of the input audio signal is classified by combining classifications of each of the two or more spatial components.

14. The method of claim 13, wherein the two or more spatial components comprise a center channel and a side channel, the method further comprising:
calculating a power of the side channel; and
classifying the side channel in response to determining that the power of the side channel exceeds a threshold.

15. The method of claim 13, wherein the two or more spatial components comprise a diffuse component and a direct component; or wherein the input audio signal is separated into the two or more spatial components in response to determining that the input audio signal comprises stereo audio.

16. (canceled)

17. The method of claim 13, wherein classifying the media type of the input audio signal comprises separating the input audio signal into a vocal component and a non-vocal component.

18. The method of claim 17, wherein the input audio signal is separated into the vocal component and the non-vocal component in response to determining that the input audio signal comprises a single audio channel.

19. The method of claim 17, wherein classifying the media type of the input audio signal comprises:
classifying the vocal component as one of: 1) speech; or 2) non-speech;
classifying the non-vocal component as one of: 1) music; or 2) non-music,
wherein the media type of the input audio signal is classified by combining the classification of the vocal component and the classification of the non-vocal component.

20. An apparatus or system configured for implementing the method of claim 1.

21. (canceled)

22. One or more non-transitory media having software stored thereon, the software including instructions for controlling one or more devices to perform the method of claim 1.
